(19) United States
(12) Patent Application Publication
(10) Pub. No.: US 2015/0267644 A1
(43) Pub. Date: Sep. 24, 2015

(54) Integrated Primary Nozzle

(71) Applicant: The Boeing Company, Chicago, IL (US)

(72) Inventors: David F. Cerra, Woodinville, WA (US); Paul R. Tretow, Mukilteo, WA (US); Robert H. Willie, Everett, WA (US); Robert B. Carter, III, Bellevue, WA (US)

(73) Assignee: The Boeing Company, Chicago, IL (US)

(21) Appl. No.: 14/219,143

(22) Filed: Mar. 19, 2014

(51) Int. Cl. F02K 1/82; B23P 15/00

(52) U.S. Cl. CPC F02K 1/827; B23P 15/008

(57) ABSTRACT

Apparatus, systems and methods provide for an integrated primary nozzle. The integrated primary nozzle defines an annular vent and includes an integrated panel that includes an acoustic treatment. The integrated panel includes a combination of an integrally formed portion of an outer wall of the primary nozzle, an acoustic treatment, and an aft cowl. An annular vent is defined by a gap between an outer surface of the integrated panel and an inner surface of a forward cowl.

### BACKGROUND

Industries, such as airlines and airline manufacturers, are always looking for ways to lower costs that are associated with flying. For example, airline manufacturers attempt to find different ways of lowering maintenance costs, reducing emissions, reducing noise and reducing fuel consumption.

Fuel prices are generally very volatile and are one of the largest expenses of an airline. Reducing these fuel expenses can help an airline compete in today's competitive market. Airline manufacturers may attempt to improve fuel efficiency using a variety of different methods. For example, more fuel efficient engines may be designed, aerodynamics may be improved, the weight of parts may be reduced, and the like. For example, changing the design of the primary nozzle or the vents that are associated with an engine, such as a bypass turbofan turbine engine, may be changed in an attempt to increase the performance of the engine. Improving these, and other, characteristics, however, can be very challenging and costly.

### SUMMARY

It should be appreciated that this Summary is provided to introduce a selection of concepts in a simplified form that are further described below in the Detailed Description. This Summary is not intended to be used to limit the scope of the claimed subject matter.

Apparatus, system and methods described herein are directed at providing an integrated primary nozzle. According to an aspect, an integrated primary nozzle is formed using a forward cowl and an integrated panel. The integrated panel is concentric to the forward cowl and extends beyond an aft end of the forward cowl. An annular vent is formed between the outer surface of the integrated panel and the inner surface of the forward cowl. The integrated panel is an integrally formed combination of a portion of a primary nozzle outer wall, an acoustic treatment, and an aft cowl.

According to another aspect, a system for an integrated primary nozzle includes a nacelle, a forward cowl, and an integrated panel. The integrated panel is coupled to the nacelle or the engine and is disposed partially within the forward cowl. The integrated panel extends longitudinally beyond an aft end of the forward cowl. The integrated panel is an integrally formed combination of the primary nozzle outer wall, an acoustic treatment, and the aft cowl. An annular vent is defined by a gap that is between the outer surface of the integrated panel and the inner surface of the forward cowl. According to yet another aspect, a method is configured to form an integrated primary nozzle. The method includes manufacturing an integrated panel as an integrally formed combination of an aft cowl, an acoustic treatment, and a portion of a primary nozzle outer wall. A size of the annular vent is determined. The integrated panel is positioned concentrically to the forward cowl such that the annular vent has the determined size.

The features, functions, and advantages that have been discussed can be achieved independently in various embodiments of the present disclosure or may be combined in yet other embodiments, further details of which can be seen with reference to the following description and drawings.

### BRIEF DESCRIPTION OF THE DRAWINGS

FIG. 1 shows an illustration of a propulsion system that includes an integrated primary nozzle;

FIG. 2 shows a cross section schematic of an integrated primary nozzle;

FIG. 3 shows a cross section schematic of an annular vent that includes a fairing that is attached to a primary nozzle outer wall;

FIG. 4 shows a cross section schematic of an integrated primary nozzle system that includes a variable panel thickness; and

FIG. 5 shows an illustrative routine relating to manufacturing and positioning an integrated primary nozzle, according to various embodiments presented herein.

### DETAILED DESCRIPTION

The following detailed description is directed to an integrated primary nozzle. Utilizing the concepts and technologies described herein, an integrated primary nozzle is directed to one or more of a more optimally positioned annular vent, a larger acoustically treated area, a lower weight, an increase in primary nozzle performance, a reduction in part count, and a reduction in assembly hours.

Traditional annular vent designs splice multiple pieces of structure together to form an annular vent for an engine, such as a high bypass turbofan turbine engine. For example, a splice joint may be used to attach a cantilevered structure (hereinafter referred to as a “fairing”) to the aft end of the aft cowl with a stiffening bullnose at the forward end of the aft cowl. This type of design results in a relatively thick overall structure since each part that is spliced together has a different thickness. For example, using a traditional annular vent design results in a gap between the forward cowl and the fairing of the aft cowl that is larger than desired.

The integrated primary nozzle reduces the number of parts and weight from a traditional annular vent design by eliminating the splice and the fairing that is included in the traditional annular vent design as described herein. With fewer parts in the integrated primary nozzle, there may be a reduction in production and manufacturing costs by reducing the material and the assembly time and effort used to manufacture the annular vent.

The annular vent may be positioned farther aft as compared to the traditional annular vent design and the forward cowl may be moved farther aft since the gap formed by the annular vent may be reduced in size when compared to the gap that results from the traditional method of splicing multiple pieces of structure together. For example, in one embodiment the gap is reduced from about 1.5 inches to about 0.5 inches. Positioning the annular vent farther aft may result in a more optimally positioned annular vent. A larger portion of the primary nozzle outer wall may also be covered with acoustic treatment as compared to a traditional annular vent design. For example, acoustic treatment may cover the primary nozzle wall from about the aft end to a location beneath the forward cowl.

In the following detailed description, references are made to the accompanying drawings that form a part hereof, and which are shown by way of illustration, specific embodiments, or examples. Referring now to the drawings, in which like numerals represent like elements through the several figures, a configurable tray table and method for employing the same according to the various embodiments will be described.

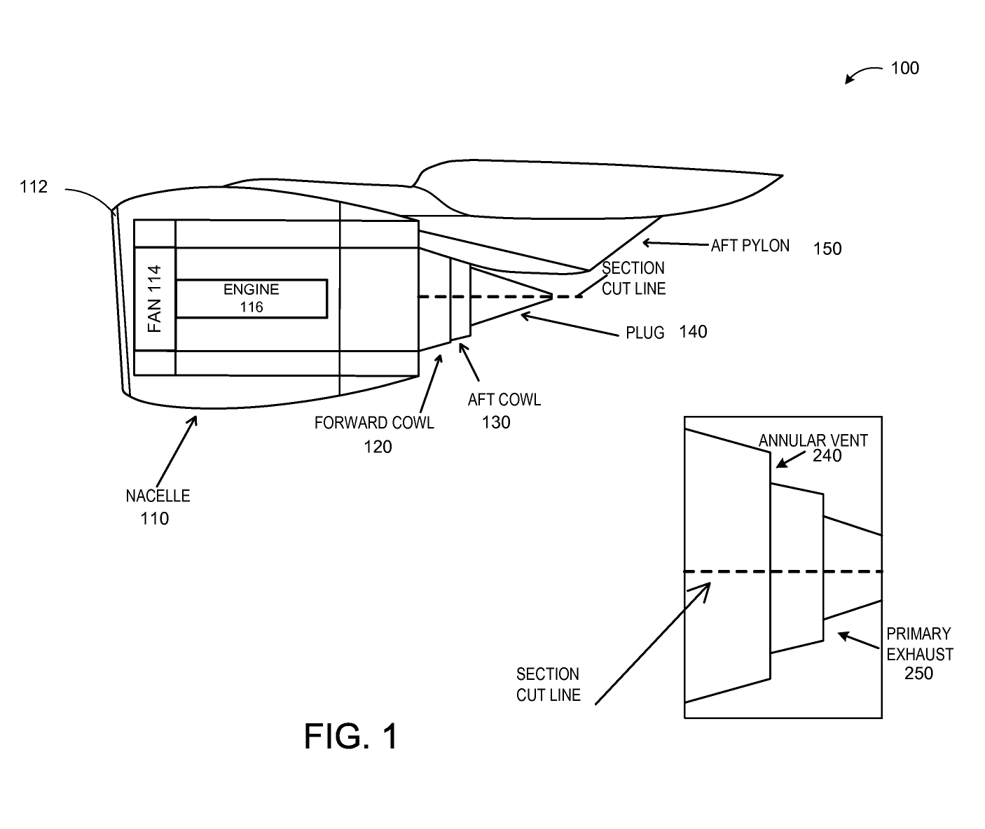

FIG. 1 shows an illustration of a propulsion system that includes an integrated primary nozzle. As illustrated, propulsion system 100 illustrates nacelle 110, inlet 112, fan 114, engine 116, forward cowl 120, aft cowl 130, plug 140 and aft pylon 150.

Propulsion system 100 may include an engine 116 (e.g., a bypass turbofan gas turbine engine) that is housed in nacelle 110. Nacelle 110 is secured to a wing (not shown) using some fastening system (e.g., a strut, pylon). Nacelle 110 includes inlet 112 that supplies air to engine 116.

Propulsion system 100 includes a fan 114 that located at a forward end of the engine 116 near inlet 112. Air that passes through fan 114 is divided into a flow that passes through engine 116, flow used for cooling, that is eventually exhausted through the annular vent 240, and a flow that passes through a fan duct. Engine 116 produces a primary exhaust flow, discharged through a primary exhaust 250. Some of the fan exhaust flow, used as cooling air, passes through an annular vent 240. The fan exhaust flow, the primary exhaust flow, and the annular vent exhaust flow form the thrust that is generated by the engine. A plug 140 may be included depending on the design.

In bypass turbofan engines, the primary exhaust flow and the fan exhaust flow may be optimized for specific engines and/or specific operating conditions. For example, the positioning and the size of the annular vent may be changed depending on the desired operating characteristics. According to an embodiment, the integrated primary nozzle described herein positions the annular vent 240 farther aft compared to traditional designs. As a result, a relatively smaller gap may also be used in forming the annular vent 240 between the forward cowl 120 and aft cowl 130 since the fairing in traditional designs is not included in the integrated primary nozzle.

The integrated primary nozzle described herein may also include more acoustic treatment as compared to traditional designs. For example, acoustic treatment may be disposed longitudinally along a substantial length of the aft cowl 130 and beneath a portion of the forward cowl 120.

The illustration of propulsion system 100 is not meant to imply physical or architectural limitations to the manner in which different embodiments may be implemented. Other components in addition to and/or in place of the ones illustrated may be used. Some components may also be unnecessary in some embodiments. The following figures provide more detail with regard to the integrated primary nozzle.

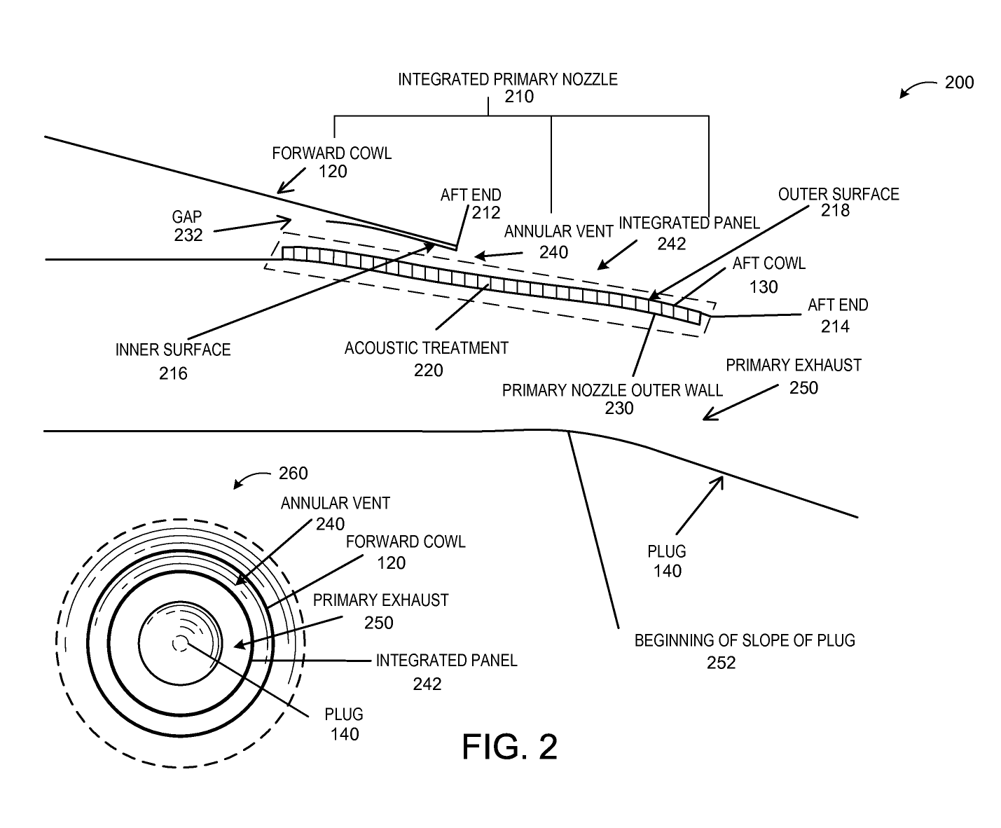

FIG. 2 shows a cross section schematic of an integrated primary nozzle. As illustrated, integrated primary nozzle system 200 includes forward cowl 120, aft cowl 130, plug 140 and acoustic treatment 220. According to an embodiment, the integrated primary nozzle 210 includes forward cowl 120, annular vent 240, and integrated panel 242 configured for a bypass turbofan turbine engine for commercial aircraft. In this regard, integrated panel 242 includes the combination of an integrally formed aft cowl 130, acoustic treatment 220, and a primary nozzle outer wall 230. The integrated primary nozzle, however, may be configured and designed for other types of applications (e.g., boats, smaller planes, cars).

As illustrated, annular vent 240 includes a space or gap 232 that is formed between and defined by the inner surface 216 of forward cowl 120 and an outer surface 218 of integrated panel 242. Instead of having a fairing that is connected to the primary nozzle outer wall 230, aft cowl 130 is integrated with primary nozzle outer wall 230 and acoustic treatment 220 to form integrated panel 242. In the example that is shown in FIG. 2, integrated primary nozzle includes acoustic treatment 220 that extends to within at least a few inches (e.g., three inches, two inches, one inch) of the aft end 214 of the integrated panel 242.

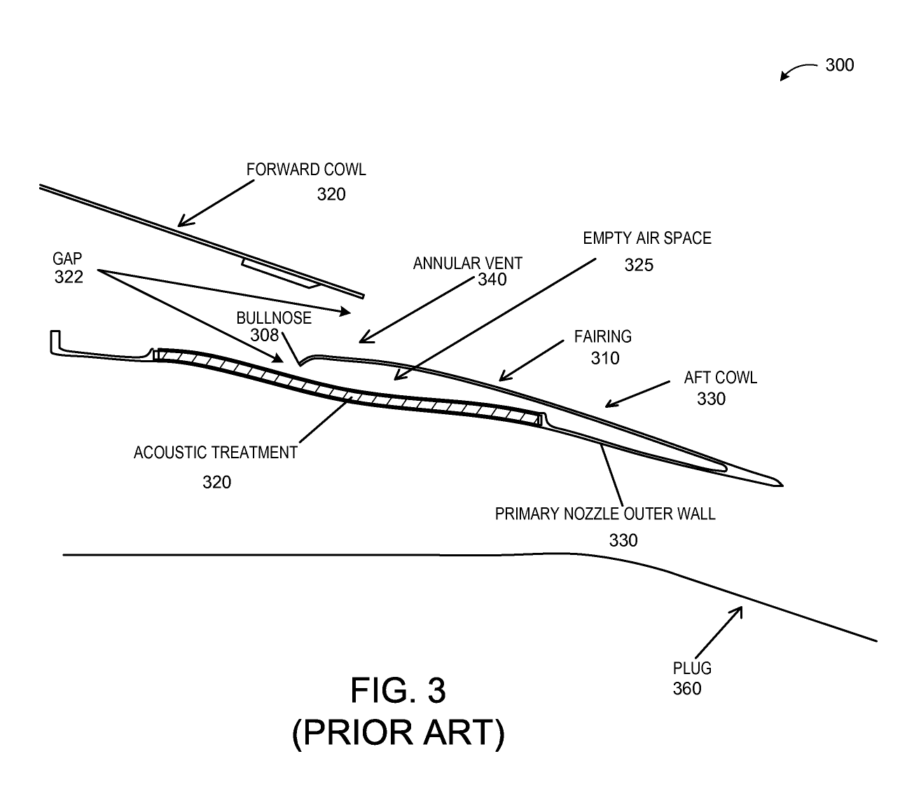

In contrast to splicing multiple pieces of structure together that results in relatively large gaps between the forward cowl 120 and aft cowl 130 (See FIG. 3 and related discussion), the integrated primary nozzle includes an annular vent system having a relatively smaller gap 232 between the forward cowl 120 and primary nozzle outer wall 230. According to an embodiment, the gap 232 that is formed between the inner surface 216 of forward cowl 120 and the outer surface 218 of the integrated panel 242 is approximately 0.5 inches. Other sized gaps may be configured depending on the desired characteristics. Changing the characteristics of an annular vent 240 may decrease Specific Fuel Consumption (SFC) or increase SFC. For example, a properly positioned and pressurized annular vent may improve SFC by 0.25% or more.

As illustrated, aft cowl 130 is coupled to primary nozzle outer wall 230 and forms an integrated panel 242 that is substantially a same uniform thickness. Comparing FIG. 3 to FIG. 2 it can be seen that the integrated primary nozzle system 200 reduces the number of parts used to define the annular vent 240. For example, fairing 310 that is shown in FIG. 3 is removed. According to an embodiment, more acoustic treatment 220 may be included in the integrated panel 242 that is part of the integrated primary nozzle system 200 as compared to acoustic treatment 320 as shown in FIG. 3. The aft end 212 of the forward cowl 120 may be positioned at various locations relative to integrated panel 242. According to an embodiment, the aft end 212 of forward cowl 120 is positioned farther aft toward aft end 214 of integrated panel 242 as compared to the position of the aft end of the forward cowl in traditional annular vent designs (e.g., as shown in FIG. 3). According to an embodiment, the aft end 212 of forward cowl 120 may be positioned farther aft by several inches. According to an embodiment, the aft end 212 of forward cowl 120 is less than about 18 inches from the aft end 214 of integrated panel 242. According to another embodiment, the aft end 212 of forward cowl 120 is positioned within twelve inches of a beginning of slope of plug 252.

View 260 illustrates an end view looking directly into the nacelle 100 and showing annular vent 240, primary exhaust 250 and plug 140. As illustrated, the forward cowl 120 and integrated panel 242 are concentric to one another. Integrated panel 242 is positioned partially within forward cowl 120 to form annular vent 240 having a gap 232. According to other embodiments, a forward cowl may be disposed in a different manner to an integrated panel. For example, the integrated panel 242 may be formed to have a square opening, or some other shape opening (e.g. oval) and the forward cowl may be formed to have a larger square opening, or some other shape opening.

Acoustic treatment 220 is directed at reducing the noise of the engine. One source of noise from an aircraft is engine noise. Different acoustic treatments may be used according to embodiments of the invention. For example, acoustic treatment 220 may be an acoustic liner that includes a honeycomb core sandwiched between a perforated front sheet and a solid back sheet. The perforated front sheet is aligned with the primary flow so that the sound waves pass through the front sheet and into the honeycomb core of acoustic treatment 220 where the sound waves are dissipated. The number of holes, the pattern of the holes, as well as other characteristics of acoustic treatment 220 may be changed depending on the application. Further, other types of acoustic treatments may be used. The acoustic treatment 220 that is shown in integrated primary nozzle system 200 may extend from a location beneath forward cowl 120 to near an aft end (or all of the way to the end) of the primary nozzle outer wall 230. According to an embodiment, the acoustic treatment extends to within a few inches (e.g., 1 inches, 2 inches, 3 inches) of the aft end 214 of integrated panel 242.

FIG. 3 shows a cross section schematic of an annular vent that includes a fairing that is attached to a primary nozzle outer wall. As illustrated, primary nozzle system 300 includes forward cowl 320, aft cowl 330 and plug 360.

Forward cowl 320 and aft cowl 330 form an annular vent 340. A fairing 310 is attached to the primary nozzle outer wall 330 and is not integrated with the acoustic treatment 320. As can be seen, there is a gap 322 between fairing 310 and acoustic treatment 320. Further, there is an empty air space 325 between aft cowl 330, fairing 310 and primary nozzle outer wall 330.

As illustrated, fairing 310 is spliced to primary nozzle outer wall 330. In the fairing design illustrated in FIG. 3, the fairing 310 that includes the bullnose 308 at the end, the empty air space 325 adds to the thickness of the acoustic treatment 320 and primary nozzle outer wall 330. The empty air space 325 is designed to account for the relative motion of the surfaces during operation (e.g., a flight). For example, the different surfaces deflect varying amounts depending on the flying conditions.

As illustrated, the gap 322 between the forward cowl 120 and fairing 310 is approximately 1.5 inches. Other traditional annular designs may have different gaps, but the gaps are larger compared to the gap 232 of an integrated primary nozzle as shown in FIG. 2 meeting the same requirements as described herein. As can be seen, the position of annular vent 340 is farther forward as compared to the position of annular vent 240 as illustrated in FIG. 2.

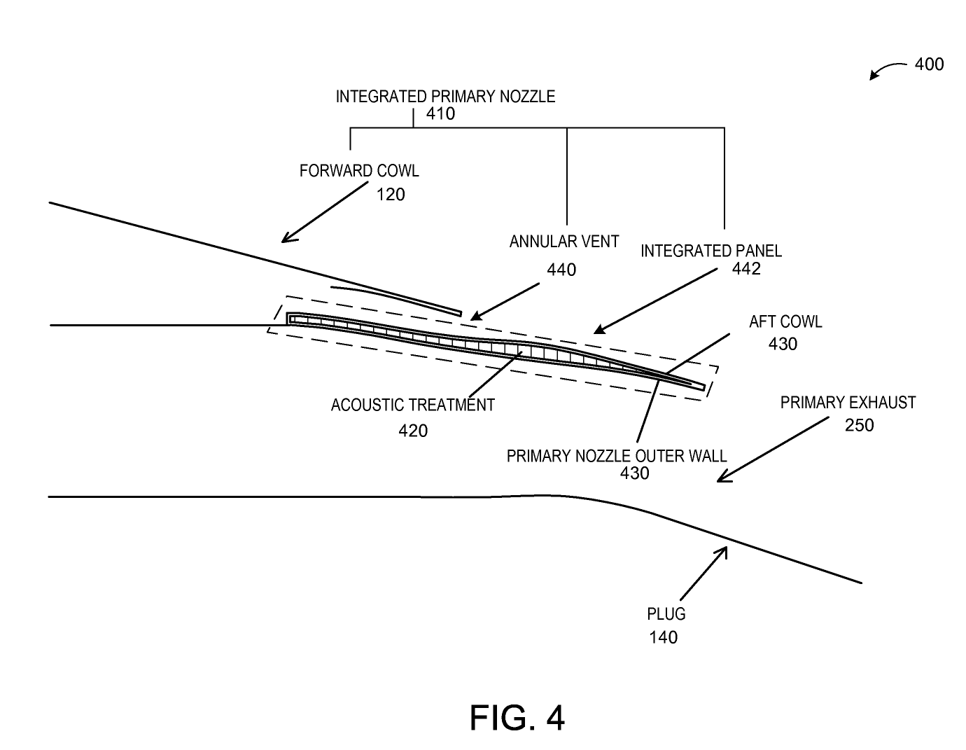

Acoustic treatment 320 is illustrated on primary nozzle outer wall 330. The acoustic treatment 320 in FIG. 3 covers less area than the acoustic treatment that is illustrated in the integrated primary nozzle system 200 that is shown in FIG. 2 or the integrated primary nozzle system 400 that is shown in FIG. 4.

Turning now to the description of FIG. 4, an embodiment illustrating a variable panel thickness is described. FIG. 4 shows a cross section schematic of an integrated primary nozzle system 400 that includes a variable panel thickness. As illustrated, integrated primary nozzle 410 includes an annular vent 440, forward cowl 120, and integrated panel 442. In this regard, the integrated panel 442 includes the combination of an integrally formed aft cowl 430, acoustic treatment 420, and primary nozzle outer wall 430.

The integrated primary nozzle system 400 is substantially similar to the integrated primary nozzle system 200 as illustrated in FIG. 2. In the current example, integrated panel 442 is a variable thickness panel that is formed by primary nozzle outer wall 430, acoustic treatment 420 and aft cowl 430. In contrast to having a substantially constant panel thickness, the integrated panel 442 thickness varies at different locations. The thicknesses may be determined based on various design characteristics. For example, a portion of integrated panel 442 may be thicker or thinner at one or more locations to adjust the flow over the portion of the integrated panel 442.

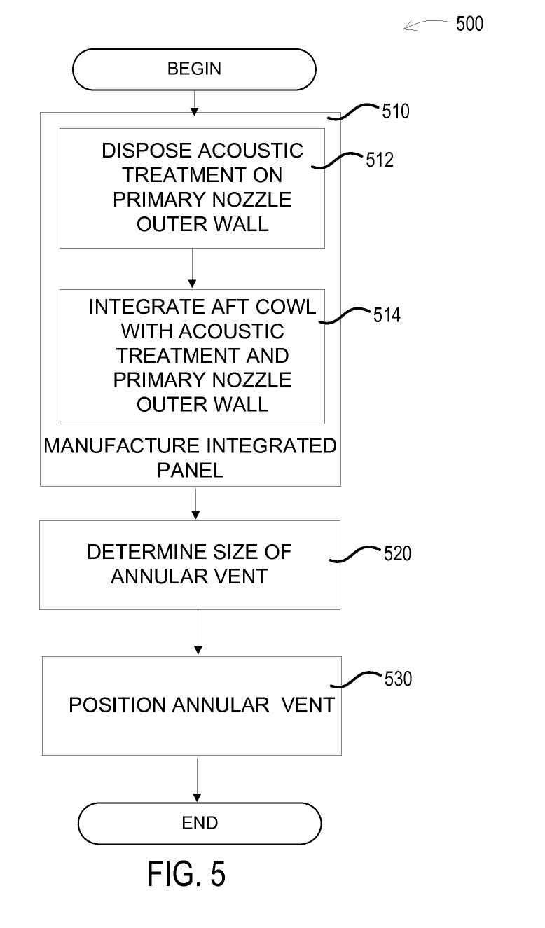

Turning now to FIG. 5, an illustrative routine is described relating to manufacturing and positioning an integrated primary nozzle. It should be appreciated that more or fewer operations may be performed than shown in the figures and described herein. These operations may also be performed in a different order than those described herein.

Routine 500 begins at operation 510, where an integrated panel is manufactured. According to an embodiment, the integrated panel is an integrally formed combination of an aft cowl, acoustic treatment, and a portion of a primary nozzle outer wall. The acoustic treatment may be disposed between a primary nozzle outer wall and an aft cowl.

At operation 512, the acoustic treatment is disposed on the primary nozzle outer wall. According to an embodiment, the acoustic treatment is a honeycomb structure that includes small holes drilled on the side of the primary flow coming from an engine. Other types of acoustic treatments may be used. As discussed above, the acoustic treatment may be disposed along a length of the primary nozzle outer wall to an aft end of the aft cowl, near the aft end of the aft cowl, or some other length. According to an embodiment, the acoustic treatment is applied to the primary nozzle wall from about the aft end of the primary nozzle outer wall to a location beneath the inner surface of the forward cowl.

At operation 514, the aft cowl is integrated with the acoustic treatment and the primary nozzle outer wall. For example, a structure, such as sheet metal, may be coupled to the top of the acoustic treatment. According to another embodiment, the acoustic treatment is manufactured to include a top sheet that is directly integrated onto the acoustic treatment. According to an embodiment, the aft cowl is integrated with the acoustic treatment and the primary nozzle outer wall such that there is not a gap at the forward end.

From operation 510, routine 500 continues to operation 520, where a size of the annular vent is determined. The size of the annular vent may be determined using a variety of criteria. For example, the size of the annular vent may be based on the desired operating characteristics. According to an embodiment, the size of the annular vent is based on a size of the gap between the forward cowl and the integrated panel. Due to the structure and manufacturing method disclosed herein, a smaller gap may be used in forming the annular vent 240, 440 positioned between the forward cowl 120 and the integrated panel 242, 442 since the fairing in traditional designs is not included in the integrated primary nozzle as described herein. According to an embodiment, the gap may be sized to approximately 0.5 inches. Other gap sizes may be used depending on the application. For example, some turbine engines may operate more efficiently having a gap size of 0.3 inches to 0.6 inches and the like.

From operation 520, routine 500 continues to operation 530. At operation 520, the annular vent is positioned. As discussed above, the integrated panel may be positioned relative to the forward cowl to adjust the performance characteristics of the annular vent. According to an embodiment, the annular vent is positioned farther aft (e.g., 4 inches, 5 inches, 6 inches) as compared to a traditional annular vent as illustrated in FIG. 3. Routine 500 then flows to an end operation and returns to processing other actions.

The subject matter described above is provided by way of illustration only and should not be construed as limiting. Various modifications and changes may be made to the subject matter described herein without following the example embodiments and applications illustrated and described, and without departing from the true spirit and scope of the present disclosure, which is set forth in the following claims.

What is claimed is:

1. An integrated primary nozzle, comprising:
a forward cowl;
an integrated panel concentric to the forward cowl and extends longitudinally beyond an aft end of the forward cowl, wherein the integrated panel is an integrally formed combination of a primary nozzle outer wall, an acoustic treatment, and an aft cowl; and
an annular vent formed between an outer surface of the integrated panel and an inner surface of the forward cowl.

2. The integrated primary nozzle of claim 1, wherein the acoustic treatment is disposed between the aft cowl and the primary nozzle outer wall.

3. The integrated primary nozzle of claim 1, wherein the annular vent includes a gap defined by the outer surface of the integrated panel and the inner surface of the forward cowl.

4. The integrated primary nozzle of claim 1, wherein a gap between the outer surface of the integrated panel and the inner surface of the forward cowl at an aft end of the forward cowl is less than one inch.

5. The integrated primary nozzle of claim 1, wherein the aft end of the forward cowl is positioned within a foot of an aft end of the integrated panel.

6. The integrated primary nozzle of claim 1, wherein a thickness of the integrated panel is one of: a constant thickness or a variable thickness.

7. The integrated primary nozzle of claim 1, wherein the acoustic treatment extends from a location before the aft end of the forward cowl to within three inches of an aft end of the integrated panel.

8. A system for an integrated primary nozzle, comprising:
a nacelle;
a forward cowl that is coupled to the nacelle;
an integrated panel that is coupled to either the nacelle or an engine and is disposed partially within the forward cowl and extends longitudinally beyond an aft end of the forward cowl, wherein the integrated panel is an integrally formed combination of a primary nozzle outer wall, an acoustic treatment, and an aft cowl; and
an annular vent that is defined by a gap that is between an outer surface of the integrated panel and an inner surface of the forward cowl.

9. The system of claim 8, wherein the gap is less than one and half inches.

10. The system of claim 8, wherein the annular vent is positioned within a foot and a half of an aft end of the forward cowl.

11. The system of claim 8, wherein the gap is less than one inch.

12. The system of claim 8, wherein a thickness of the integrated panel is a variable thickness.

13. The system of claim 8, wherein the acoustic treatment is a honeycomb structure that is disposed between the aft cowl and the primary nozzle outer wall.

14. The system of claim 8, wherein the acoustic treatment extends from an aft end of the forward cowl to within six inches of an aft end of the integrated panel.

15. A method for forming an integrated primary nozzle, comprising:
manufacturing an integrated panel as an integrally formed combination of an aft cowl, an acoustic treatment, and a portion of a primary nozzle outer wall;
determining a size of an annular vent; and
positioning the integrated panel concentrically to a forward cowl such that the annular vent has the determined size.

16. The method of claim 15, wherein positioning the integrated panel comprises placing a portion of the integrated panel within an inner surface of the forward cowl.

17. The method of claim 15, wherein positioning the integrated panel comprises positioning the integrated panel within twelve inches of a beginning of a slope of a plug.

18. The method of claim 15, wherein determining the size of the annular vent comprises determining the size of the annular vent such that a gap that is formed between an inner surface of the forward cowl and an outer surface of the integrated panel is less than one inch.

19. The method of claim 15, wherein manufacturing the integrated panel comprises manufacturing the integrated panel to have a substantially constant thickness.

20. The method of claim 15, wherein manufacturing the integrated panel that includes the acoustic treatment comprises sandwiching a honeycomb acoustic treatment between an aft cowl and a primary nozzle outer wall.
